(19) United States
(12) Patent Application Publication
(10) Pub. No.: US 2018/0266976 A1
(43) Pub. Date: Sep. 20, 2018

(54) Nanoparticle based Moisture Sensor

(71) Applicant: Anushka Naiknaware, Portland, OR (US)

(72) Inventor: Anushka Naiknaware, Portland, OR (US)

(21) Appl. No.: 15/462,826

(22) Filed: Mar. 18, 2017

(51) Int. Cl. G01N 27/04

(52) U.S. Cl. CPC G01N 27/048

(57) ABSTRACT

A sensor for detecting moisture comprising a substrate, a pattern made on the substrate using a nanoparticle conductive ink, and having at least two conductive terminals to the pattern. The sensor may further include an electronic device to monitor the impedance at the terminals, and can provide representative audio or visual output; or may transmit the measured impedance or the corresponding representative status over wired or wireless interface to other electronic devices. The interfaced electronic devices may further transmit all the received data to data servers for additional processing and Internet services.

### CROSS-REFERENCE TO RELATED APPLICATION

This application claims priority from U.S. Provisional Patent Application Ser. No. 62/309,473 titled Carbon Nanoparticle based Biocompatible Sensor for Wound Management filed Mar. 17, 2016; and U.S. Provisional Patent Application Ser. No. 62/403,803 titled Space-Filling Curves based Moisture Sensors of Precisely Controlled Sensitivities filed Oct. 5, 2016.

### BACKGROUND

In many applications it is desirable to determine the extent of moisture infusion has occurred over a surface or within a volume of a medium. The nature of such surfaces and mediums can be wide ranging. For instance, an example of a surface can be a human skin; while an example of a medium can be a volume created by superabsorbent polymers (SAPs). Many times, these moisture sensors must also be made from biocompatible materials so that they can be used in health care applications where direct or indirect exposure to humans is imminent. These sensors must operate over variety of surface areas from a few millimeter square to several centimeter square. In some applications, one can also envision these sensors having sizes of several square meters. Furthermore, these sensors must be minimally intrusive in its application and thus must be exceptionally thin. The thickness of the sensor element needs to be as small as a few nanometers. Additionally, it is desirable that the sensors have precisely controlled sensitivities. In other words, sensor design must allow precise response to predetermined extents of moisture infusion; and should respond within predetermined duration. Most often it is desirable to have the response duration to be as small as possible.

Conventionally, the moisture infusion sensors either use changes in the conductivity a of surface or a medium; or capacitance changes across electrically isolated conductive elements placed in proximity or within the medium. Such techniques cannot be used effectively to meet all the previously described criterion. Most specifically, conventional sensors are neither size scalable nor cost effective.

### SUMMARY

This patent disclosure describes a novel moisture sensor for detecting moisture comprising a substrate, a pattern made on the substrate using a nanoparticle conductive ink, and having at least two conductive terminals to the pattern. The sensor may further include an electronic device to monitor the impedance at the terminals, and can provide representative audio or visual output; or may transmit the measured impedance or the corresponding representative status over wired or wireless interface to other electronic devices. The interfaced electronic devices may further transmit all the received data to data servers for additional processing and Internet services. The sensor overcomes the issues of conventional moisture sensors including, but not limited to, limited area scalability, higher costs, and complex and expensive mass production.

### BRIEF DESCRIPTION OF THE DRAWINGS

For a more complete understanding of the invention, reference is made to the following description and accompanying drawings, in which:

FIG. 1 An exemplary use of moisture sensor designed using inventive principles described in this patent disclosure in a wound-management application; and

FIG. 2 An exemplary set of patterns showing various possiblities using space-filling curves. For illustrative purpose a few patterns are redrawn using higher thickness. Possible terminal locations are marked with a letter T.

### DETAILED DESCRIPTION

The nanoparticles conductive ink in this patent disclosure consists of conductive nanoparticles dispersed or suspended in a solution. Most often the solution is aqueous, but can be non-aqueous. Some examples of conductive nanoparticles include, but not limited to, are silver nanoparticles, gold nanoparticles, copper nanoparticles, carbon nanotubes, graphene flakes, and variety of conducting polymer nanocomposites. These nanoparticles can be complex molecules in general. Such complex molecules can be synthesized by variety of techniques including, but not limited to, conjugation processes. The ink may contain additional ingredients to obtain numerous but specific properties. Examples of such ingredients include, but not limited to, are color pigments, color dyes, solvents, humectants, polymeric resins, water soluble adhesives, defoamer/antifoaming agents, pH modifiers, surfactants and biocides. The nanoparticle conductive ink can be formulated in variety of ways and may use variety of steps in varying sequences consisting, bath sonification, probe sonification, ball milling and multi-stage filtering. The preparation of the ink using these elements should be such that a resultant print made from the ink is not fully moisture-proof or waterproof. In other words, the printed patterns using these inks must smudge to at least some degree when exposed to moisture. If biocompatibility is desired, the solution preparation requires special consideration to the ingredients. For example, silver nanoparticles and graphene flakes are established to be cytotoxic when used in open wounds. In such cases, activated carbon nanoparticles and similar biocompatible nanoparticles provides optimum solution. These activated carbons nanoparticles could be derived from wood, coconut shells or coal. Alternatively, they can be synthetically prepared. Furthermore, any additional ingredients for obtaining specific properties of the ink must also be biocompatible. In the simplest form, the activated carbon nanoparticles may be suspended in distilled water using probe sonification with a water soluble biocompatible adhesive. Depending on the properties of the substrate on which the pattern is being printed, water soluble adhesive may not be needed.

The pattern in this patent disclosure can be made of various sizes and shapes. Furthermore, the varying elements within the pattern can have varying widths and thicknesses. he pattern may be mathematically derived using fractal techniques. Some patterns may use subset of fractals called space-filling curves. These curves fill up the area without overlapping with itself, and thus are ideally suited for satisfying the requirement that the sensors may need to operate over varying surface area sizes.

The conductive terminals in this patent disclosure for monitoring the impedance can be judiciously placed anywhere on the pattern. In general, the number of terminals can two or more. The conductive terminals are used to interface the sensor to the electronic circuit for measuring the impedance of the sensor. The conductive terminals can be made of any conductive material such as, but not limited to, gold, silver, copper. electronic soldering materials or conductive glues. In some cases, conductive wires may be directly interfaced with the sensor using the same or modified version of nanoparticle conductive ink used as an adhesive. If biocompatibility is desired, these conductive materials should also be biocompatible.

The printing of patterns in this disclosure on substrate can be accomplished using any of the processes. Some example of the processes, but not limited to, are offset lithography, flexography, digital printing technologies such as inkjet and xerography, gravature, and screen printing.

The substrate referred in this patent disclosure can be any material or a surface having low conductivity. These substrates can be sturdy or flexible. Example of these include, but not limited to, are papers of variety of kinds including 100% cotton paper, plastic, natural and synthetic fabrics, rubber and polytetrafluorethylene (PTFE).

In normal operation, when moisture is absent, the sensor pattern's impedance is determined mostly by the resistance offered by various paths within the pattern. The conductive nanoparticles provide the conductive path for electrons between the terminals. When the sensor is exposed to moisture, the moisture dilutes the concentration of conductive nanoparticles over unit volume and over unit surface area. Furthermore, smudging and thinning out of the printed nanoparticle conductive pattern over a larger surface area acts as an additional contributing factor towards disturbing the flow of electrons. One thing to note that, the moisture itself may have conductivity due to its contaminants, and thus the collective response should be appropriately designed by providing, for example, a relatively lower conductive path through the original sensor pattern than through the infusing moisture containing contaminants.

The varying conductance due to infusion of moisture into the sensor can be evaluated by electronic circuit at the terminals of the sensor. A representative value of the impedance can then be indicated locally by a visual or audio indicator. In general, the sensor may be interfaced via wire or wirelessly to other electronic devices such as, but not limited to, programmable controllers, tablets, mobile phone and data-loggers. These devices can further transfer the sensor data to remote servers for cloud based monitoring and processing.

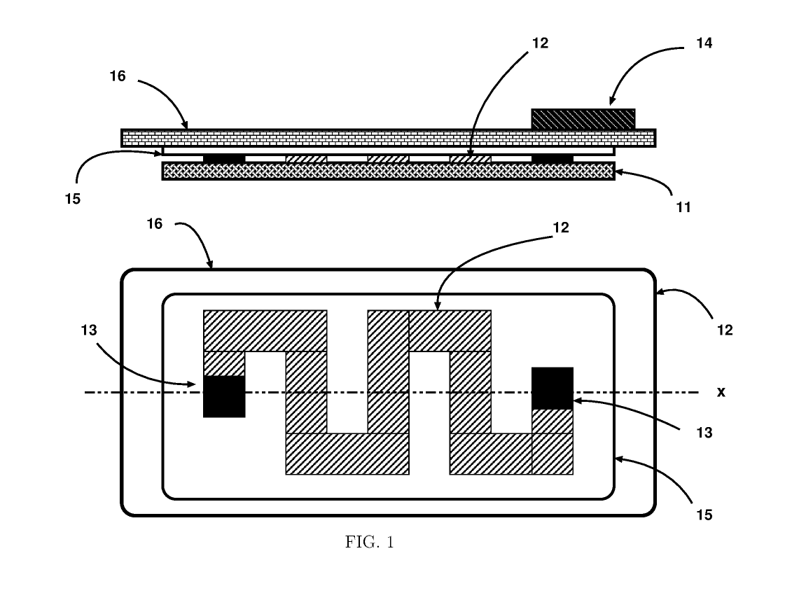

FIG. 1. shows the exemplary application of the moisture sensor designed using the inventive principles of the invention described in this patent disclosure. The moisture sensor is embedded inside a bandage for wound-management. Two views are shown. The side view is a cut-intersection of the bandage across the line marked-x from the bottom view of the bandage. The bandage consists of a gauze 11 and a moisture sensor pattern 12 printed with a nanoparticle conductive ink. The moisture sensor has two terminals 13. The terminals are connected to a wireless electronic device 14. The sensor is printed on substrate 15. In this case, the substrate is made of flexible cotton paper. Conductive wiring exists between terminals 13 and electronic device 14. Electronic device 14 has wireless capabilities to connect with a mobile phone or a tablet, where the status of electrical impedance across the terminals and/or its representative values are transmitted for real-time monitoring. The overall arrangement consisting the moisture sensor is encapsulated inside an adhesive sheet 16 of a typical bandage which is waterproof and is made of plastic (PVC, polyethylene or polyurethane). The bandage containing the moisture sensor can be arranged in variety of other combinations.

The sensor monitors the condition of wound by monitoring the moisture content. If the moisture content is sensed to be higher, an alert is sent to change the bandage.

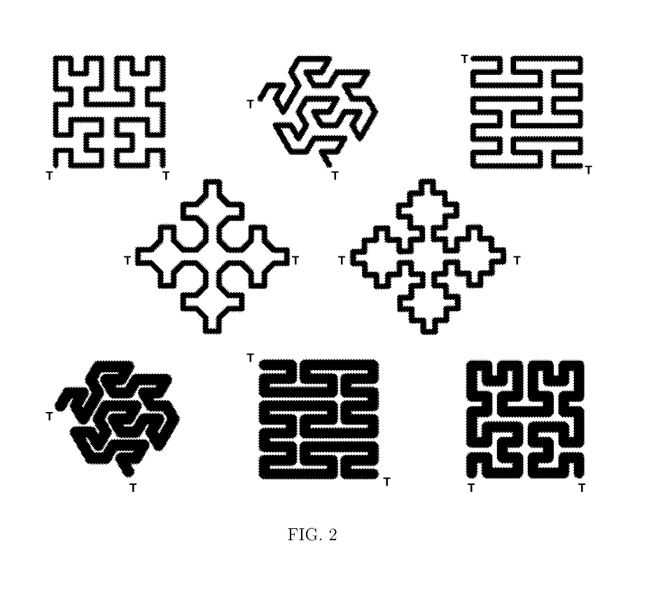

Although the application in FIG. 1 uses a simple pattern, the pattern can be complex and be made of series and parallel combination of multiple patterns. FIG. 2 illustrates some additional examples.

The inventive principle of this patent disclosure have been described above with reference to some specific example embodiments, but these embodiments can be modified in arrangement and detail without departing from the inventive concepts. Such changes and modifications are considered to fall within the scope of the claims.

What is claimed:

1. A sensor for detecting moisture comprising:
a substrate;
a pattern made on the substrate using a nanoparticle conductive ink; and
having at least two conductive terminals to the pattern.

2. The sensor of claim 1 further comprising an electronic circuit for monitoring the electrical impedance across the conductive terminals

3. The sensor of claim 1 and claim 2 further comprising a visual indicator representing the state of monitored electrical impedance across the conductive terminals

4. The sensor of claim 1 and claim 2 further comprising an audio indicator corresponding to the state of monitored electrical impedance across the conductive terminals

5. The sensor of claim 1 and claim 2 further comprising a wired interface to at least one electronic device

6. The sensor of claim 1 and claim 2 further comprising a wireless interface to at least one electronic device

7. The sensor of claim 1, claim 2 and claim 5 further comprising transferring of the measured data and representative state of the sensor to data server

8. The sensor of claim 1, claim 2 and claim 6 further comprising transferring of the measured data and representative state of the sensor to data server

9. The sensor of claim 1 where the pattern is made from a fractal

10. The sensor of claim 1 where the pattern is made from a space-filling curve

11. The sensor of claim 1 where the pattern is made from series and parallel combination of two or more patterns
